(19) United States
(12) Patent Application Publication
(10) Pub. No.: US 2015/0114712 A1
(43) Pub. Date: Apr. 30, 2015

(54) ELECTRICAL CONNECTOR AND MANUFACTURING METHOD THEREOF

(71) Applicant: LOTES CO., LTD, Keelung (TW)

(72) Inventor: Ted Ju, Keelung (TW)

(21) Appl. No.: 14/590,422

(22) Filed: Jan. 6, 2015

Related U.S. Application Data
(63) Continuation-in-part of application No. 14/094,376, filed on Dec. 2, 2013.

(30) Foreign Application Priority Data
Sep. 20, 2013 (CN) 201310427630.2

(51) Int. Cl. H01R 4/02

(52) U.S. Cl. CPC H01R 4/027
USPC 174/84 R

(57) ABSTRACT

An electrical connector and a manufacturing method. The electrical connector is used for electrically connecting a first electronic element having protruding conductive portions in the bottom thereof to a second electronic element, includes an insulating body located below the first and above the second electronic element, a conductor, a conducting region disposed on the lower surface of the insulating body, and a conducting line disposed in the insulating body and conducting the conductor and the conducting region. Upper surface of the insulating body has accommodation holes. Aperture of the accommodation hole is greater than outer diameter of the conductive portion. The conductor is provided in each of the accommodation holes. The accommodation hole has low-melting point liquid metal conductor. When the conductive portion enters the accommodation hole, the liquid metal adheres to the conductive portion, and forms a conductive path between the conductive portion and the conductor.

### CROSS-REFERENCE TO RELATED APPLICATION

This non-provisional application is a continuation-in-part application of U.S. patent application Ser. No. 14/094,376, filed on Dec. 2, 2013, entitled “ELECTRICAL CONNECTOR AND MANUFACTURING METHOD THEREOF,” by Ted Ju, which itself claims priority under 35 U.S.C. §119(a) on Patent Application No. 201310427630.2 filed in P.R. China on Sep. 20, 2013, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to an electrical connector and a manufacturing method thereof, and more particularly to an electrical connector capable of implementing stable electrical connection and a manufacturing method thereof.

### BACKGROUND OF THE INVENTION

An electrical connector is generally used for signal transmission between two electronic elements that are not electrically connected directly. For example, signal transmission between a chip module in a ball grid array (BGA) encapsulation form and a circuit board is implemented through a BGA electrical connector. The electrical connector includes an insulating body and a terminal disposed in the insulating body. The terminal is provided with an elastic contact portion. A solder ball of the chip module is pressed and connected to the elastic contact portion to implement electric contact. When the chip module or the electrical connector shakes under an external force, transient open circuit between the elastic contact portion of the terminal and the solder ball of the chip module easily occurs, thereby affecting signal transmission between the chip module and the circuit board.

Therefore, it is necessary to design a new electrical connector and a manufacturing method thereof to overcome the above problem.

### SUMMARY OF THE INVENTION

In one aspect, the present invention is directed to an electrical connector thereof, which is capable of eliminating transient open circuit between an electronic element and an electrical connector, thereby improving the stability of electrical connection and signal transmission between the two.

In one embodiment, an electrical connector is provided for electrically connecting a first electronic element to a second electronic element. The bottom of the first electronic element has a plurality of protruding conductive portions. The electrical connector includes an insulating body, a conducting region and a conducting line. The insulating body is located below the first electronic element and above the second electronic element. The upper surface of the insulating body is provided with a plurality of accommodation holes. The aperture of the accommodation hole is greater than the outer diameter of the conductive portion. A conductor is provided in each of the accommodation holes. The conducting region is disposed on the lower surface of the insulating body to be electrically connected to the second electronic element. The conducting line is disposed in the insulating body and conducting the conductor and the conducting region. The accommodation hole is provided with low-melting point liquid metal to be electrically conducted with the conductor. When the conductive portion enters the accommodation hole, the low-melting point liquid metal adheres to and contacts with the conductive portion, so that the low-melting point liquid metal forms a conductive path between the conductive portion and the conductor.

As a further improvement of the above embodiment, the low-melting point liquid metal wraps the periphery of a contact area of the conductive portion, so as to isolate the contact area from being in contact with the air.

Further, the upper surface of the insulating body has an elastic sealing layer. When the first electronic element is pressed down, the elastic sealing layer is compressed to prevent the low-melting point liquid metal from leaking. The elastic sealing layer is provided with a plurality of through holes corresponding to the accommodation holes, for the conductive portions to pass through. When the first electronic element is pressed down, the upper and lower surfaces of the elastic sealing layer are closely attached to the lower surface of the first electronic element and the upper surface of the insulating body respectively.

Further, a cover covers the upper surface of the insulating body, and the cover seals openings of the accommodation holes. The portion of the cover corresponding to the accommodation hole is transparent.

Further, the insulating body further includes a penetration hole penetrating the lower surface of the insulating body. The penetration hole is in communication with the accommodation hole. The conducting line is disposed on the wall surface of the penetration hole.

Further, the penetration hole has a plug, so as to prevent the low-melting point liquid metal from leaking out of the accommodation hole downwards. The bottom of the plug does not exceed the lower surface of the insulating body downwards.

Optionally, the plug is made of a metal material, and the bottom of the plug extends downwards to form the conducting region.

Further, the low-melting point liquid metal adheres to and contacts with a solder ball disposed at the bottom of the first electronic element. A transition portion between the side wall and the bottom of the accommodation hole is arc-shaped. The depth of the accommodation hole is greater than the spherical radius of the solder ball.

In another embodiment, the accommodation hole is a blind hole, the insulating body is further provided with a penetration hole penetrating vertically through the insulation body, and the conducting line is disposed on the wall surface of the penetration hole, and is electrically connected to the conductor in the accommodation hole through a metal line.

In a further embodiment, the insulating body further includes a penetration hole disposed below the accommodation hole and in communication with the accommodation hole. A conducting element is disposed in the penetration hole. Two ends of the conducting element forms the conductor and the conducting region.

In one embodiment, the accommodation hole includes a wall and a bottom, and the conductor is disposed at the wall and bottom of the accommodation hole.

In another aspect, the present invention is directed to a manufacturing method of an electrical connector. The electrical connector is used for electrically connecting a first electronic element to a second electronic element. The bottom of the first electronic element has a plurality of protruding conductive portions.

In one embodiment, the method includes:

s1. providing an insulating body, opening a plurality of accommodation holes on the upper surface of the insulating body, where the aperture of the accommodation hole is greater than the outer diameter of the conductive portion, and opening, in the insulating body, a plurality of penetration holes penetrating the lower surface of the insulating body;

s2. coating a layer of metal substance on a bottom of the accommodation hole and wall surface of the penetration hole, so as to form a conductor and a conducting line respectively, where the conducting line conducts the conductor, and the conducting line extends downwards to be electrically conducted with the second electronic element; and

s3. placing low-melting point metal in the accommodation hole, where the low-melting point metal is electrically conducted with the metal substance, and the low-melting point metal is used to be in contact with the conductive portion entering the accommodation hole.

As a further improvement of the above embodiment, in step s3, the low-melting point metal is solidified into particles and then placed into the accommodation hole.

As an optional improvement of the above embodiment, in step s3, a low-melting point metal in a liquid form is placed directly into the accommodation hole.

Further, in step s1, the penetration hole is opened below the accommodation hole and is in communication with the accommodation hole; in step s2, the metal substance is coated in the penetration hole first to form the conducting line, and the metal substance is coated in the accommodation hole to form the conductor at the same time, where the conductor is electrically conducted with the conducting line.

Further, a plug is then provided, and the plug is plugged in the penetration hole to seal the bottom of the accommodation hole.

As an improvement of the above embodiment, the plug is made of a metal material and is electrically conducted with the conducting line, and the plug extends downwards to the lower surface of the insulating body to form the conducting region so as to be electrically connected to the second electronic element.

The above embodiment further includes the following step: disposing an elastic sealing layer on the upper surface of the insulating body, where the elastic sealing layer is provided with a plurality of through holes corresponding to the accommodation holes, for the conductive portions to pass through.

The above embodiment further includes the following step: disposing a cover on the upper surface of the insulating body, where the cover seals openings of the accommodation holes.

Compared with the related art, in the present invention, the low-melting point liquid metal is disposed in the accommodation hole to be electrically conducted with the conductor, and when the conductive portion of the chip module enters the accommodation hole, the low-melting point liquid metal adheres to and contacts with the conductive portion, so that the low-melting point liquid metal forms a conductive path between the conductive portion and the conductor. By means of the manner of establishing a conductive path through the low-melting point liquid metal, when the first electronic element shakes slightly under an external force, the surface of the conductive portion is at least locally adhered with the low-melting point liquid metal, so that transient open circuit between the conductive portion and the electrical connector may be avoided, and the first electronic element still keeps electrical connection with the second electronic element through the conductor, thereby ensuring desirable signal transmission between the first electronic element and the second electronic element.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a three-dimensional exploded view of a first embodiment of an electrical connector according to one embodiment of the present invention.

FIG. 2 is a sectional view of FIG. 1.

FIG. 3 is a schematic view of elements in FIG. 2 after being assembled.

FIG. 4 is a schematic view of a chip module not being pressed downwards.

FIG. 5 is a schematic view of the chip module in FIG. 4 after being pressed downwards.

FIG. 6 is a partial enlarged view of FIG. 5.

FIG. 7 is a schematic view of a second embodiment of an electrical connector according to one embodiment of the present invention.

FIG. 8 is a schematic view of a third embodiment of an electrical connector according to one embodiment of the present invention.

FIG. 9 is a schematic view of a fourth embodiment of an electrical connector according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

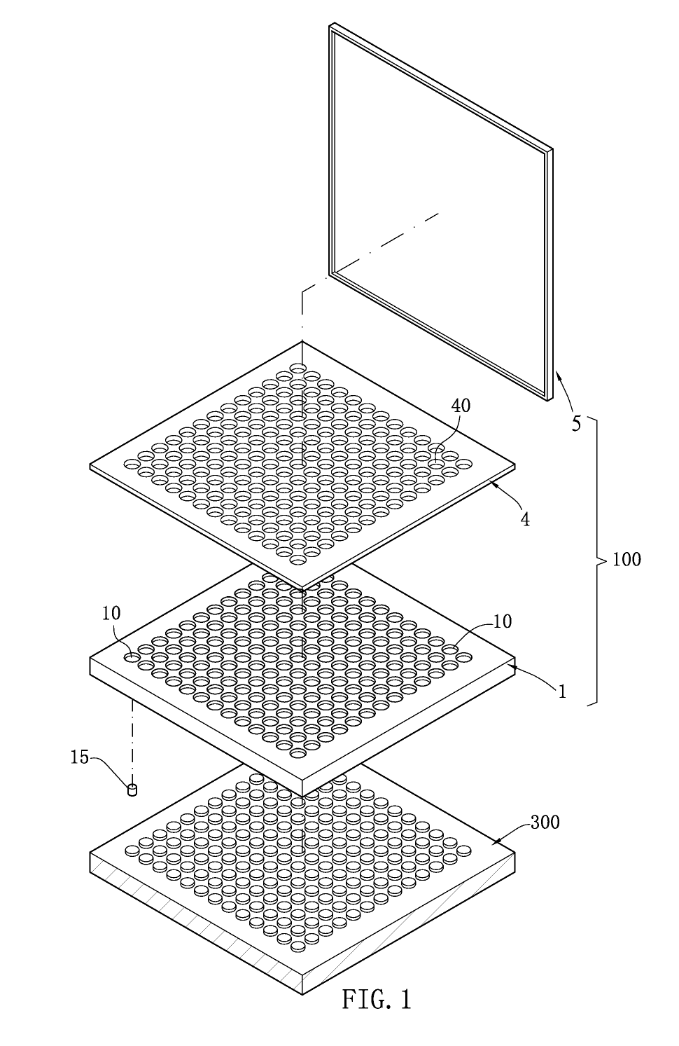

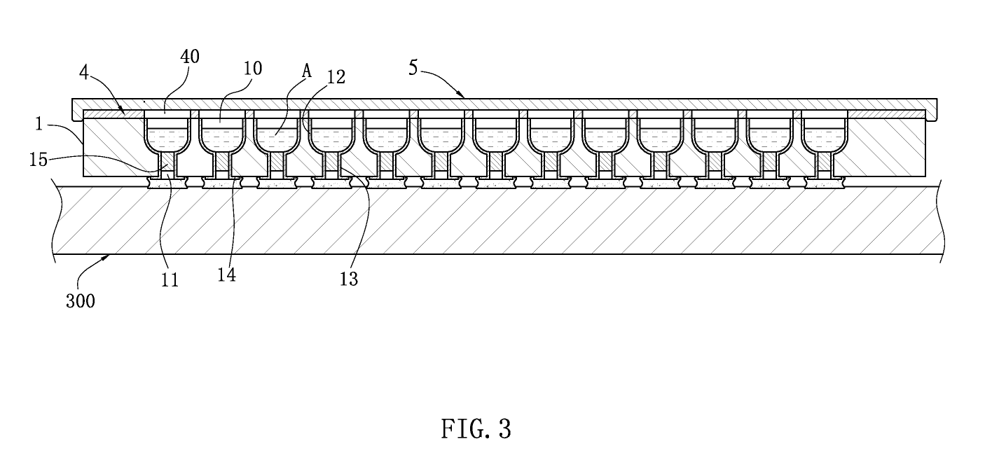

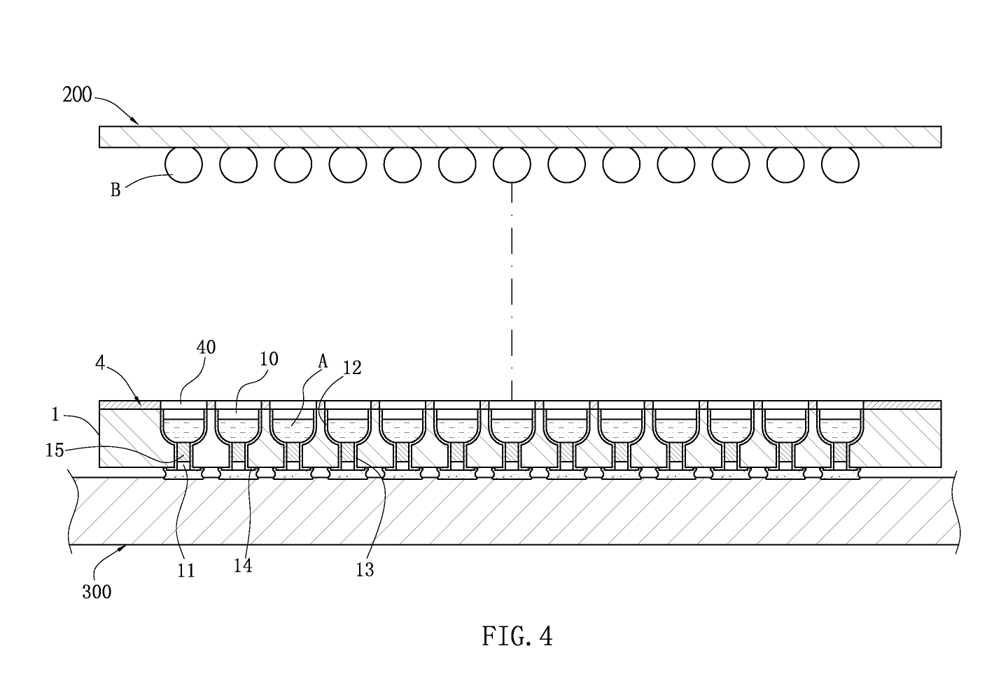

As shown in FIGS. 1-6, as a first embodiment of the present invention, an electrical connector 100 is used for electrically connecting a BGA chip module 200 to a circuit board 300. The bottom of the chip module 200 is protruded with conductive portions B. In this embodiment, the conductive portion B is solder balls B, and in other embodiments, it may also be a protruding copper pillar, or other protruding conductive materials and shapes.

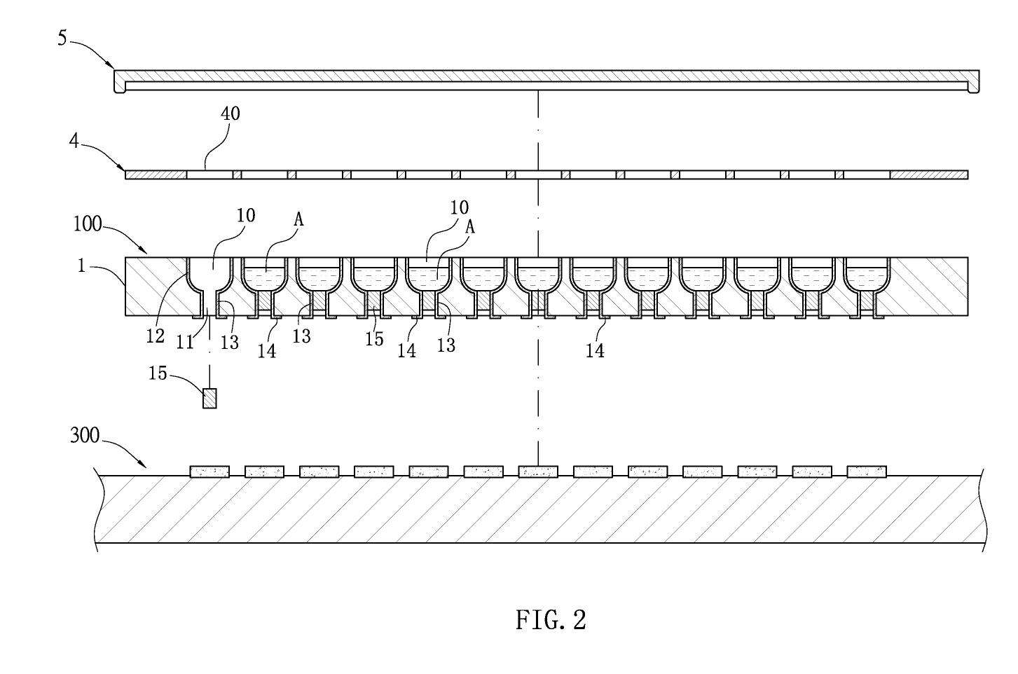

As shown in FIG. 2, the electrical connector 100 includes an insulating body 1. The insulating body 1 has a plurality of accommodation holes 10 penetrating the upper surface of the insulating body 1, and a plurality of penetration holes 11 correspondingly located below the accommodation holes 10. The penetration holes 11 penetrate the lower surface of the insulating body 1 and are in communication with the accommodation holes 10. The depth of the accommodation hole 10 is greater than the spherical radius of the solder ball B on the chip module 200, and the aperture of the accommodation hole 10 is greater than the outer diameter of the solder ball B. The inner diameter of the accommodation hole 10 should be greater than the inner diameter of the penetration hole 11, so as to form a step at a junction of the two. The accommodation hole 10 has a side wall and a bottom. In order to reduce the volume of the accommodation hole 10 as much as possible, an R angle is disposed at the bottom of the accommodation hole 10, that is to say, a transition portion between the side wall and the bottom of the accommodation hole 10 is set to be arc-shaped.

Referring to FIGS. 2-5, the side wall and the bottom of the accommodation hole 10 are disposed with a conductor 12. The side wall of the penetration hole 11 is disposed with a conducting line 13. The conducting line 13 is connected to the conductor 12. The conducting line 13 extends downward to the lower surface of the insulating body 1 so as to form a conducting region 14 for being welded to the circuit board 300. A plug 15 is inserted in the penetration hole 11. The bottom of the plug 15 does not exceed the lower surface of the insulating body 1 downward so that the conducting region 14 can be easily welded to the circuit board 300. The top of the plug 15 seals the bottom of the accommodation hole 10 so that a cup-shaped accommodation cavity is formed in the accommodation hole 10 by the conductor 12. The inner diameter of the accommodation cavity is slightly greater than the maximum diameter of the solder ball B on the chip module 200, and the depth of the accommodation cavity is greater than the spherical radius of the solder ball B so that most part of the solder ball B can enter the accommodation cavity. In other embodiments, the conductor 12 may only be disposed at the side wall or the bottom of the accommodation hole 10, as long as the conductor 12 locates in the accommodation hole 10.

The accommodation cavity is provided with low-melting point liquid metal A, and the low-melting point liquid metal A is electrically conducted with the conductor 12. The low-melting point liquid metal A has a low melting point and is conductive, which is in liquid form at the room temperature. The low-melting point liquid metal A may be composed of, for example, one element selected from indium, gallium, and tin, and may also be an alloy composed of two or three elements thereof. In this embodiment, gallium and indium in a proper proportion may be used to form a low-melting point alloy, for example, a gallium alloy containing 25% indium, which melts at 16° C., and if the temperature is higher than the melting point, gallium and indium can form the alloy automatically during mixing and grinding. When the amount of the low-melting point liquid metal A is little, the low-melting point liquid metal A is sporadically adhered to the solder ball B to form contact with the solder ball B. In order to avoid oxidation of a contact area of the solder ball B, the amount of the low-melting point liquid metal A may be increased, so that the low-melting point liquid metal A wraps the periphery of the contact area of the solder ball B, and prevent the contact area from contacting with the air.

In this embodiment, as a preferred embodiment, a layer of elastic sealing layer 4 is disposed on the upper surface of the insulating body 1. The elastic sealing layer 4 has a plurality of through holes 40 corresponding to the accommodation holes 10, for the solder balls B to pass through. When the chip module 200 is pressed down, the upper and lower surfaces of the elastic sealing layer 4 are closely attached to the lower surface of the chip module 200 and the upper surface of the insulating body 1 respectively, thereby preventing the low-melting point liquid metal A of the accommodation hole 10 from leaking, further preventing the low-melting point liquid metal A in adjacent accommodation holes 10 from adhering to each other, and avoiding the short circuit phenomenon of the low-melting point liquid metal A in the adjacent accommodation holes 10. Further, a cover 5 covers the elastic sealing layer 4, and the cover 5 seals openings of the accommodation holes 10. In order to facilitate perspective detection by optical equipment to see whether each of the accommodation holes 10 is provided with the low-melting point liquid metal A, the cover 5 is made of a transparent material. In other embodiments, only the elastic sealing layer 4 or only the cover 5 is provided.

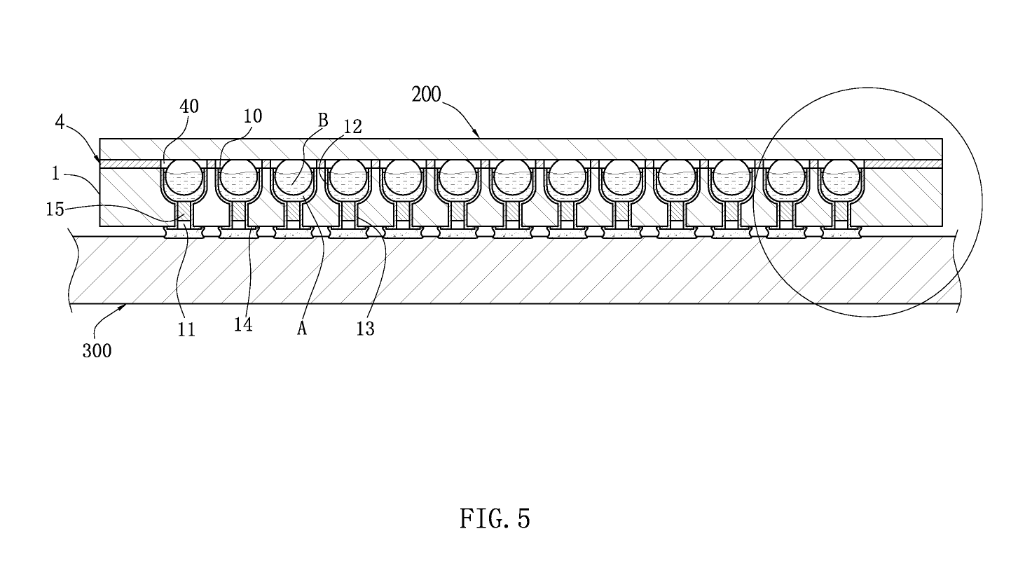

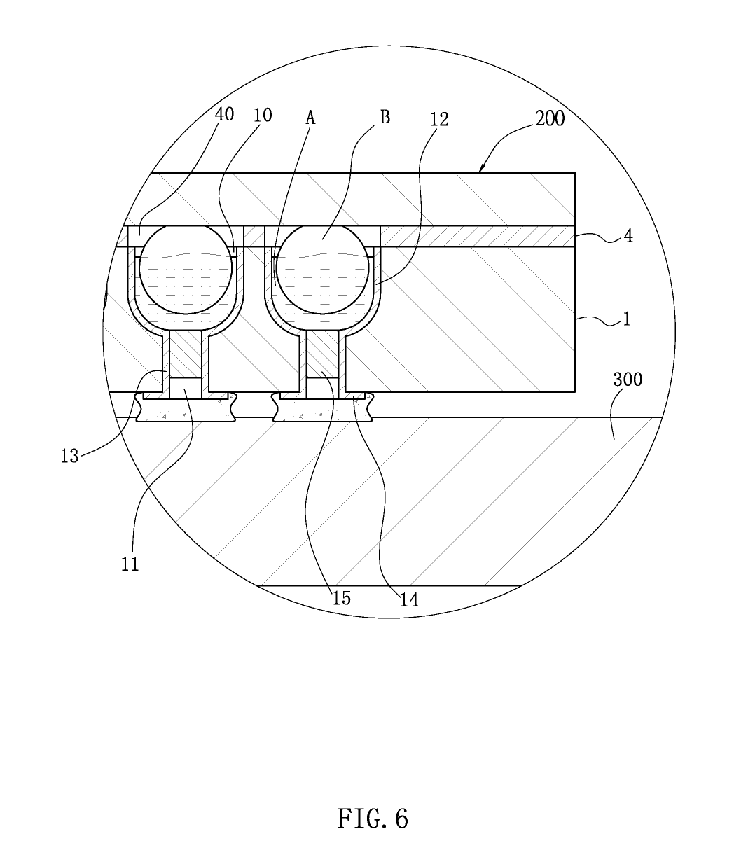

FIG. 5 and FIG. 6 show a use state of the electrical connector 100 according to one embodiment of the present invention. Before use, the cover 5 is removed first, and then the chip module 200 is pressed downwards to the electrical connector 100. Each of the solder balls B may enter the corresponding accommodation hole 10 downward through the corresponding through hole 40. Specifically, the solder ball B enters the accommodation cavity formed by the conductor 12. The amount of the low-melting point liquid metal A in the accommodation cavity may be set to fill about two thirds of the depth of the accommodation cavity, as long as the low-melting point liquid metal A does not overflow from the accommodation cavity. Because the inner diameter of the accommodation cavity is slightly greater than the maximum diameter of the solder ball B, the depth of the accommodation cavity is greater than the spherical radius of the solder ball B, the chip module 200 can be pressed to enable each solder ball B to enter the accommodation cavity, so that the low-melting point liquid metal A submerges the solder ball B over the centre of sphere. The low-melting point liquid metal A submerges over the centre of sphere, so that a safe distance of the chip module 200 to keep electrical connection upon shaking is longer. That is to say, when the chip module 200 being shaken drives the solder balls B to shift upward to a certain extent, horizontal sides of each solder ball B are still adhered with a part of the low-melting point liquid metal A, and the low-melting point liquid metal A maintains electrical connection with the conductor 12 on the side wall of the accommodation hole 10, thereby ensuring the stable electrical connection between the solder ball B and the electrical connector 100 without generating transient open circuit, and avoiding the horizontal sides of the solder ball B from scraping and damaging the conductor 12 on the side wall of the accommodation hole 10. Moreover, when the solder ball B enters the accommodation hole 10, the low-melting point liquid metal A wraps the surface of the solder ball B, so as to isolate the contact area from the air, thereby avoiding oxidation of the contact area.

Referring to FIG. 2, in one embodiment, a manufacturing method of the electrical connector 100 includes the following steps.

First, an insulating body 1 is provided, and a plurality of penetration holes 11 is opened on the lower surface of the insulating body 1. The aperture of the penetration holes 11 is small.

After that, a layer of metal conductive substance is coated on the wall surface of each penetration hole 11, so as to form the conducting line 13. The conducting line 13 further extends downward to the lower surface of the insulating body 1 to form a conducting region 14.

Then, a plurality of plugs 15 is provided. The size of the plugs 15 matches with the aperture of the penetration holes 11. The plug 15 is inserted into the corresponding penetration hole 11, so that the top of the penetration hole 11, that is, the bottom of the accommodation hole 10, is sealed by the plug 15.

After that, accommodation holes 10 are opened on the upper surface of the insulating body 1. The accommodation holes 10 have a larger aperture and are correspondingly located above the penetration holes 11. The side wall and the bottom of the accommodation holes 10 are then coated with the metal conductive substances to form the conductor 12. The conductor 12 is electrically connected to the conducting line 13, and the conductor 12 forms a cup-shaped accommodation cavity.

Then, low-melting point metal A is placed into each accommodation hole 10. Specifically, the low-melting point metal A is solidified into particles in an environment having a temperature lower than the melting point, and the particles are placed into each accommodation hole 10. The insulating body 1 is then placed at the room temperature (that is an environment having a temperature higher than the melting point), so that the particles restore to the liquid form to fill the accommodation holes 10. Alternatively, the process may be performed at a temperature lower than the melting point of the low-melting point metal A, in which the low-melting point metal A in the liquid form is placed directly into the accommodation holes 10.

After that, an elastic sealing layer 4 having a plurality of through holes 40 is provided. The elastic sealing layer 4 is adhered on the upper surface of the insulating body 1, and the through holes 40 of the elastic sealing layer 4 corresponds to the openings of the accommodation holes 10.

Finally, a cover 5 is provided. The cover 5 buckles above the elastic sealing layer 4, and the opening of each accommodation hole 10 is sealed by the cover 5.

In another embodiment, the method may be as follows.

First, an insulating body 1 is provided. A plurality of penetrating holes 11 are opened on the lower surface of the insulating body 1, and a plurality of accommodation holes 10 are opened on the upper surface of the insulating body 1. Each penetrating hole 11 has a small aperture, each accommodation hole 10 has a large aperture, and the accommodation holes 10 are located correspondingly above the penetrating holes 11.

After that, a layer of metal substrate is coated on the wall surface of the penetration hole 11, to form the conducting line 13. The conducting line 13 further extends downward to the lower surface of the insulating body 1 to form a conducting region 14. At the same time, the side wall and the bottom of the accommodation holes 10 are coated with the metal conductive substances to form the conductor 12. The conductor 12 is electrically connected to the conducting line 13, and the conductor 12 forms a cup-shaped accommodation cavity.

Then, a plurality of plugs 15 is provided. The size of the plugs 15 matches with the aperture of the penetration holes 11. The plug 15 is inserted into the corresponding penetration hole 11. The top of the penetration hole 11, that is, the bottom of the accommodation hole 10, is sealed by the plug 15.

Then, the low-melting point metal A is placed into each accommodation hole 10. Specifically, the low-melting point metal A is solidified into particles in an environment having a temperature lower than the melting point. The particles are placed into each accommodation hole 10. The insulating body 1 is then placed at the room temperature (that is an environment having temperature higher than the melting point), so that the particles restore to the liquid form to fill the accommodation holes 10. Alternatively, the process may be performed at a temperature lower than the melting point of the low-melting point metal A, in which the low-melting point metal A in the liquid form is placed directly into the accommodation holes 10.

After that, an elastic sealing layer 4 having a plurality of through holes 40 is provided. The elastic sealing layer 4 is adhered on the upper surface of the insulating body 1, and the through holes 40 of the elastic sealing layer 4 correspond to the openings of the accommodation holes 10.

Finally, a cover 5 is provided. The cover 5 buckles above the elastic sealing layer 4, and the opening of each accommodation hole 10 is sealed by the cover 5.

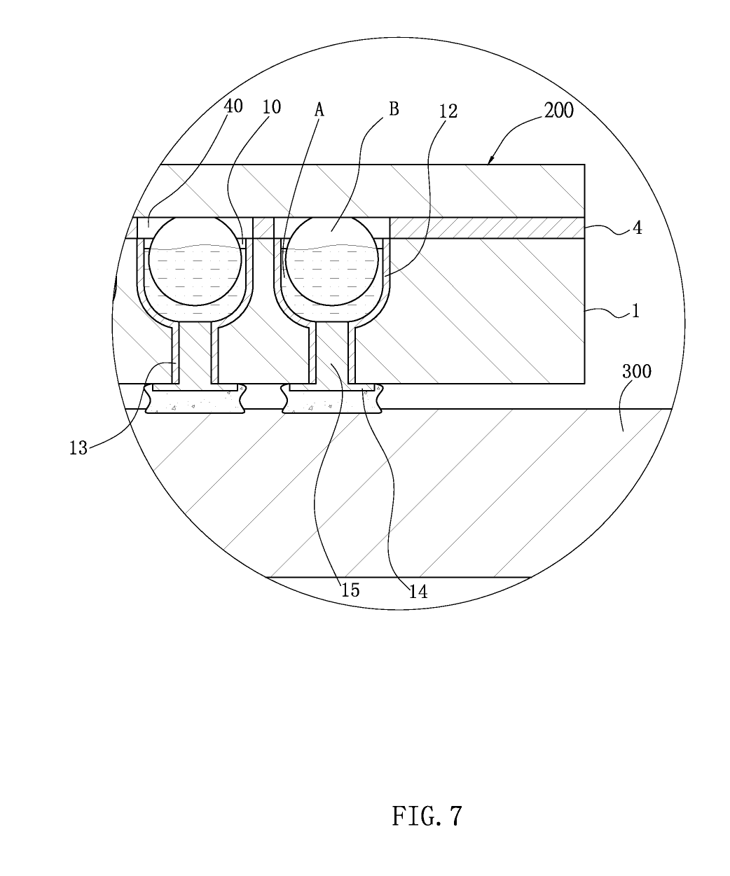

FIG. 7 shows an electrical connector 100 according to a second embodiment of the present invention, which has a structure substantially the same as that of the first embodiment. The differences lie in that: each of the plugs 15 is made of a metal material, and the plug 15 extends integrally downward, exceeding the lower surface of the insulating body 1, to form the conducting region 14 for electrically connecting the circuit board 300. The manufacturing method thereof is substantially the same as the method described above in the first embodiment. The difference lies in that, in this embodiment, in the step of coating a layer of metal conductive substance on the wall surface of each penetration hole 11, it is not necessary to further extend the conducting line 13 formed on the wall surface of the penetration hole 11 downward to the lower surface of the insulating body 1 to form the conducting region 14. The plugs 15 are directly inserted into the penetration holes 11 to accomplish the process.

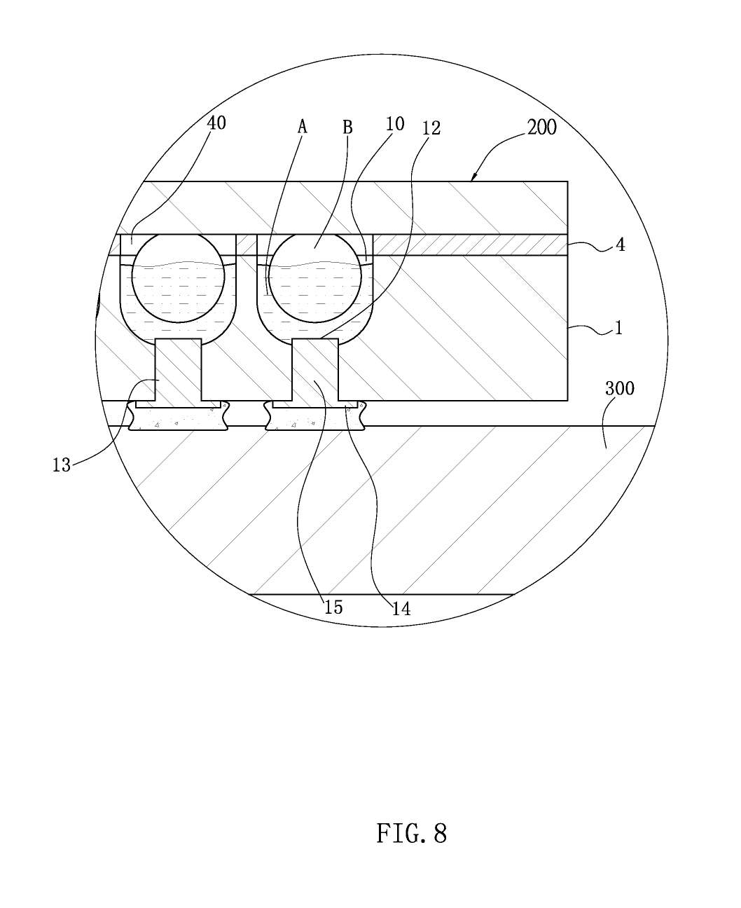

FIG. 8 shows an electrical connector 100 according to a third embodiment of the present invention, where each of the plugs 15 is made of metal material, inserted in the corresponding penetrating hole 11 disposed below the accommodation hole 10, and used as the conducting element 15. The top end of the conducting element 15 extends to the accommodation hole 10 to form the conductor 12 for electrically conducting the low-melting point metal A, and the bottom end of the conducting element 15 extends downward to form the conducting region 14.

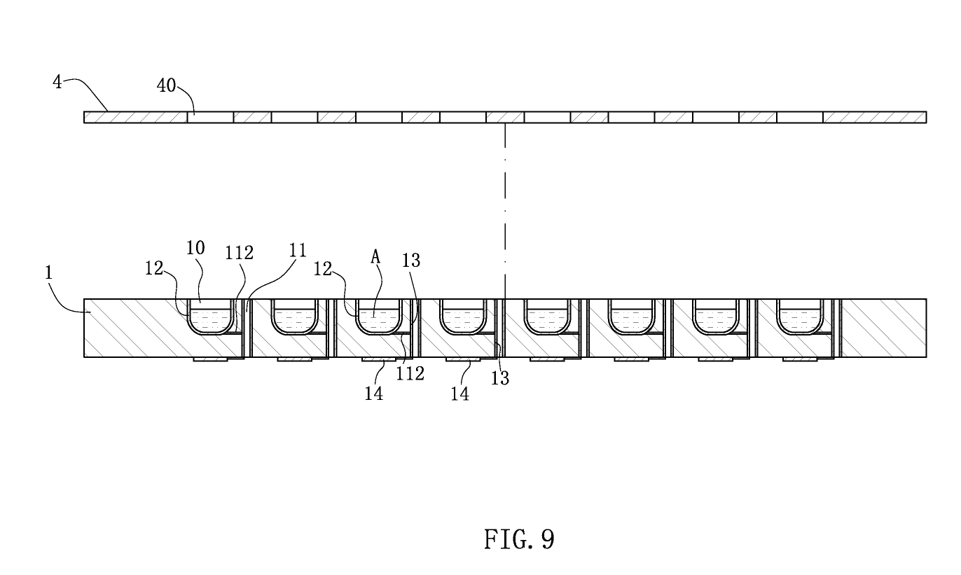

FIG. 9 shows an electrical connector 100 according to a fourth embodiment of the present invention, which has a structure substantially the same as the electrical connector 100 of the first embodiment. The differences lie in that: each of the accommodation holes 10 is a blind hole, a penetration hole 11 penetrating the insulating body 1 is opened beside the corresponding accommodation hole 10, the conducting line 13 is disposed completely on the wall surface of each of the penetration holes 11 and extends downward to the lower surface of the insulating body 1 to form the conducting region 14, the conducting line 13 is electrically connected to the conductor 12 in the accommodation hole 10 through a metal line 112, and the metal line 112 is disposed inside the insulating body 1. In another embodiment, the metal line 112 may also be disposed on the upper surface of the insulating body 1. In this embodiment, the insulating body 1 may be a circuit board, and the metal line 112 is a copper foil disposed inside the circuit board.

The manufacturing process of the electrical connector 100 in this embodiment is slightly different. When the electrical connector 100 is manufactured, the accommodation holes 10 and the penetration holes 11 may be manufactured at the same time, and the conductors 12 and the conducting lines 13 may also be manufactured at the same time. In addition, during the manufacturing, it is not necessary to plug the bottom of the accommodation hole 10 using the plug 15. The specific manufacturing process of this embodiment includes the following steps.

First, an insulating body 1 is provided. A plurality of accommodation holes 10 are opened on the upper surface of the insulating body 1. The accommodation holes 10 are blind holes. A penetration hole 11 having a smaller aperture is beside each of the accommodation holes 10. The penetration holes 11 penetrate the insulating body 1, and a metal line 112 is disposed between each penetration hole 11 and the corresponding accommodation hole 10 beside the penetration hole 11.

After that, a layer of metal conductive substance is coated on the wall surface of the accommodation holes 10 and the wall surface of the penetration holes 11, so as to form the conductor 12 in each of the accommodation holes 10. The conductor 12 forms a cup-shaped accommodation cavity. The conducting line 13 is formed in each of the penetration holes 11. The conducting line 13 is disposed completely on the wall surface of the corresponding penetration hole 11 and is electrically connected to the conductor 12 in the accommodation hole 10 through the metal line 112. The conducting line 13 further extends downward to the lower surface of the insulating body 1 to form a conducting region 14.

Then, low-melting point liquid metal A is placed into each accommodation cavity. Specifically, the low-melting point liquid metal A is solidified into particles in an environment having a temperature lower than the melting point. The particles are placed in each accommodation cavity, and the insulating body 1 is then placed at the room temperature (that is an environment having a temperature higher than the melting point), so that the particles restore to the liquid form to fill the accommodation cavity.

After that, an elastic sealing layer 4 having a plurality of through holes 40 is provided. The elastic sealing layer 4 is adhered on the upper surface of the insulating body 1, and the through holes 40 of the elastic sealing layer 4 correspond to the openings of the accommodation holes 10.

Finally, a cover 5 is provided. The cover 5 buckles above the elastic sealing layer 4, and the opening of each of the accommodation holes 10 is sealed by the cover 5.

In view of the above, certain embodiments of the present invention, among other things, have the following beneficial advantages.

1. The aperture of the accommodation hole 10 is greater than the outer diameter of the solder ball B, so when the chip module 200 is pressed down, the solder ball B will not impact the conductor 12 on the side wall of the accommodation hole 10, thereby avoiding the horizontal sides of the solder ball B from scraping and damaging the conductor 12.

2. The low-melting point liquid metal A is placed into the accommodation hole 10 for electrically connecting the conductor 12. When the solder ball B enters the accommodation hole 10, the low-melting point liquid metal A adheres to and contacts the solder ball B, and the low-melting point liquid metal A forms a conductive path between the solder ball B and the conductor 12. By the manner of establishing the conductive path through the low-melting point liquid metal A, when the chip module 200 shakes under an external force, the surface of the solder ball B is at least locally adhered with the low-melting point liquid metal A, so that transient open circuit between the solder ball B and the electrical connector 100 may be avoided, and the chip module 200 still maintains electrical connection with the circuit board 300 through the conductor 12, thereby ensuring desirable signal transmission between the chip module 200 and the circuit board 300.

3. Moreover, using the low-melting point liquid metal A as the conductive path between the chip module 200 and the circuit board 300 avoids the problem of soaring resistance caused by friction oxidation in a conventional elastic terminal, and relatively reduces the contact resistance between the electrical connector 100 and the solder ball B, thereby improving the electrical contact performance between the chip module 200 and the electrical connector 100.

4. The low-melting point liquid metal A can further functions to seal. When the solder ball B enters the accommodation hole 10, the low-melting point liquid metal A wraps the periphery of the contact area of the solder ball B, so as to seal the contact area to isolate the contact area from being in contact with the external air or water or the like, thereby preventing oxidation of the contact area, and finally preventing transient open circuit of the electrical connection between the solder ball B and the electrical connector 100.

5. The depth of the accommodation hole 10 is greater than the spherical radius of the solder ball B, the amount of the low-melting point liquid metal A may be controlled, so that the solder ball B is emerged in the low-melting point liquid metal A deeper, thereby forming a longer safe distance, ensuring the stable electrical connection between the solder ball B and the electrical connector 100 without generating transient open circuit, and avoiding the horizontal sides of the solder ball B from scraping and damaging the conductor 12 on the side wall of the accommodation hole 10.

6. In addition, an R angle is set at the bottom of the accommodation hole 10. That is to say, a transition portion between the side wall and bottom of the accommodation hole 10 is set to be arc-shaped, so as to reduce the volume of the accommodation hole 10 as much as possible, thereby ensuring that the low-melting point liquid metal A can submerge the solder ball B above the center of sphere while reducing the amount of the low-melting point liquid metal A as much as possible, and saving the amount of the low-melting point liquid metal and reducing the cost while guaranteeing the electrical connection.

7. The elastic sealing layer 4 is disposed above the insulating body 1, so the elastic sealing layer 4 can prevent the low-melting point liquid metal A in the accommodation hole 10 from leaking, thereby further preventing the conductive low-melting point liquid metal A in adjacent accommodation holes 10 from adhering to each other, and avoiding the short circuit phenomenon of the low-melting point liquid metal A in the adjacent accommodation holes 10.

8. The cover 5 is disposed above the elastic sealing layer 4, and the cover 5 may further prevent the low-melting point liquid metal A from leaking Since the portion of the cover 5 corresponding to the accommodation hole 10 is transparent, it is convenient for detecting whether each of the accommodation holes 10 is provided with the low-melting point liquid metal A by an optical equipment.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, for electrically connecting a first electronic element to a second electronic element, a bottom of the first electronic element having a plurality of conductive portions protruding thereof, the electrical connector comprising:
an insulating body located below the first electronic element and above the second electronic element, wherein a plurality of accommodation holes are opened on an upper surface of the insulating body, an aperture of the accommodation holes is greater than an outer size of the conductive portions, and a conductor is provided in each of the accommodation holes;
a conducting region, disposed at a bottom surface of the insulating body, for electrically connecting the second electronic element; and
a conducting line, disposed in the insulating body and electrically connecting the conductor and the conducting region,
wherein each of the accommodation holes comprises a low-melting point liquid metal for conducting the corresponding conductor, and when the conductive portions enter the accommodation holes, the low-melting point liquid metal adheres to and contacts with the corresponding conductive portion, so that the low-melting point liquid metal forms a conductive path between the conductive portion and the conductor.

2. The electrical connector according to claim 1, wherein the low-melting point liquid metal wraps a periphery of a contact area of the conductive portion, to isolate the contact area from contacting with the air.

3. The electrical connector according to claim 1, further comprising an elastic sealing layer disposed on the upper surface of the insulating body, wherein when the first electronic element is pressed down, the elastic sealing layer is compressed to prevent the low-melting point liquid metal from leaking.

4. The electrical connector according to claim 3, wherein the elastic sealing layer comprises a plurality of through holes corresponding to the accommodation holes and for the conductive portions to pass through, and when the first electronic element is pressed down, an upper surface and a lower surface of the elastic sealing layer are closely attached to a lower surface of the first electronic element and the upper surface of the insulating body respectively.

5. The electrical connector according to claim 1, further comprising a cover covering the upper surface of the insulating body, wherein the cover seals openings of the accommodation holes.

6. The electrical connector according to claim 5, wherein a portion of the cover corresponding to the accommodation holes are transparent.

7. The electrical connector according to claim 1, wherein the insulating body further comprises a plurality of penetration holes penetrating the lower surface of the insulating body, the penetration holes are in communication with the accommodation holes respectively, and the conducting line is disposed on the wall surface of each of the penetration holes.

8. The electrical connector according to claim 7, further comprising a plug disposed in each of the penetration holes, for preventing the low-melting point liquid metal from leaking out of the accommodation hole downward.

9. The electrical connector according to claim 8, wherein a bottom of the plug does not exceed the lower surface of the insulating body downward.

10. The electrical connector according to claim 8, wherein the plug is made of a metal material, and the bottom of the plug extends downward to form the conducting region.

11. The electrical connector according to claim 1, wherein a transition portion between a side wall and a bottom of the accommodation hole is arc-shaped.

12. The electrical connector according to claim 1, wherein the low-melting point liquid metal adheres to and contacts with a solder ball disposed at a bottom of the first electronic element.

13. The electrical connector according to claim 12, wherein a depth of the accommodation hole is greater than a spherical radius of the solder ball.

14. The electrical connector according to claim 1, wherein the accommodation holes are blind holes, the insulating body further comprises a plurality of penetration holes penetrating vertically through the insulation body, the conducting line is disposed on a wall surface of the corresponding penetration hole, and electrically connecting the conductor through a metal line.

15. The electrical connector according to claim 1, wherein the insulating body further comprises a penetration hole disposed below each of the accommodation holes and in communication with the corresponding accommodation hole, a conducting element is disposed in the penetrating hole, and a top end and a bottom end of the conducting element respectively form the conductor and the conducting region.

16. The electrical connector according to claim 1, wherein the accommodation hole includes a side wall and a bottom, and the conductor is disposed on the side wall and the bottom.

17. A manufacturing method of an electrical connector for electrically connecting a first electronic element to a second electronic element, a bottom of the first electronic element having a plurality of conductive portions protruding thereof, the manufacturing method comprising:
(s1) providing an insulating body, opening a plurality of accommodation holes on an upper surface of the insulating body and a plurality of penetration holes penetrating a lower surface of the insulating body, wherein an aperture of the accommodation hole is greater than an outer diameter of the conductive portion;
(s2) coating a layer of metal substrate on a bottom of the accommodation hole and wall surface of the penetration hole, to form a conductor and a conducting line respectively, wherein the conducting line is electrically connected with the conductor, and extends downward to be electrically connected with the second electronic element; and
(s3) placing a low-melting point metal into the accommodation hole, wherein the low-melting point metal is conducted with the metal substrate, and configure to electrically connect the conductive portion entering the accommodation hole.

18. The manufacturing method of claim 17, wherein in step (s3), the low-melting point metal is solidified into particles and then placed into the accommodation hole.

19. The manufacturing method of claim 17, wherein in step (s3), the low-melting point metal in a liquid form is placed into the accommodation hole.

20. The manufacturing method of claim 17, wherein
in step (s1), each of the penetration holes is opened below and in communication with the corresponding accommodation hole; and
in step (s2), the metal substrate is coated in the penetration hole to form the conducting line, and the metal substrate is coated in the accommodation hole to form the conductor, and the conductor is electrically connected with the conducting line.

21. The manufacturing method of claim 20, further comprising:
providing a plurality of plugs; and
inserting each of the plurality of the plugs to a corresponding penetrating hole to seal a bottom of the corresponding accommodation hole.

22. The manufacturing method of claim 21, wherein the plugs are made of a metal material, each plug is electrically conducting with the corresponding conducting line, and extends downward to a bottom surface of the insulating body to form the conducting region for electrically connecting the second electronic element.

23. The manufacturing method of claim 17, further comprising:
disposing an elastic sealing layer on the upper surface of the insulating body, wherein the elastic sealing layer comprises a plurality of through holes corresponding to the accommodation holes, for the conductive portions to pass through.

24. The manufacturing method of claim 17, further comprising disposing a cover on the upper surface of the insulating body, wherein the cover seals each accommodation hole.
